(19) United States
(12) Patent Application Publication
(10) Pub. No.: US 2024/0388144 A1
(43) Pub. Date: Nov. 21, 2024

(54) ELECTRICAL MACHINE

(71) Applicant: Schaeffler Technologies AG & Co. KG, Herzogenaurach (DE)

(72) Inventors: Christian Silvery, Walzbachtal (DE); Alexandre Fischer, Strasbourg (FR); Andreas Ruppert, Bühlertal (DE); Thomas Fritz, Malsch (DE)

(21) Appl. No.: 18/692,238

(22) PCT Filed: Sep. 13, 2022
(86) PCT No.: PCT/DE2022/100674

§ 371 Date: Mar. 14, 2024

(30) Foreign Application Priority Data
Sep. 15, 2021 (DE) 10 2021 123 833.1

(51) Int. Cl. H02K 1/18; H02K 11/00; H02K 11/25; H02K 15/00

(52) U.S. Cl. CPC H02K 1/18; H02K 11/0094; H02K 11/25; H02K 15/00

(57) ABSTRACT

The invention relates to an electrical machine comprising a hollow-cylindrical stator carrier (2), at least one cable (8) guided out from the interior of the stator carrier (2), and an annular disc element (3) situated on an axial end face (34) of the stator carrier (2), wherein: the outer circumference (4) of the annular disc element (3) comprises radially projecting abutment portions (5) by means of which the annular disc element (3) abuts the stator carrier (2); the annular disc element (3) comprises at least one cable guide (7) situated between two adjacent abutment portions (5); the cable (8) is situated in the cable guide (7) and the cable guide (7) secures the cable (8) at least in the circumferential direction.

### CROSS-REFERENCE TO RELATED APPLICATIONS

The present application is the U.S. National Phase of PCT Patent Application Number PCT/DE2022/100674, filed on Sep. 13, 2022, which claims priority to German Patent Application Serial Number 10 2021 123 833.1, filed on Sep. 15, 2021, the entire disclosures of which are incorporated by reference herein.

### TECHNICAL FIELD

The disclosure relates to an electric machine comprising a hollow-cylindrical stator carrier, at least one cable guided out from the interior of the stator carrier, and an annular disc element arranged on an axial end face of the stator carrier, wherein the outer circumference of the annular disc element has radially projecting abutment portions by means of which the annular disc element abuts the stator carrier.

### BACKGROUND

Electric machines are used in a wide range of applications in various fields of engineering. For example, electric machines can be used as traction motors in motor vehicles. To monitor an electric machine during operation, sensors can be arranged in the interior of the electric machine, for example. The measured values generated by the sensors can be read out via cables, for which the cables must be guided from the interior of the electric machine to the outside. Even if the sensors or cables are arranged on components that remain stationary when the electric machine is in operation, it may be necessary to guide and/or secure the cables, in particular if the electric machine is used in a moving device such as a motor vehicle.

### SUMMARY

The disclosure is therefore based on the object of providing an electric machine with improved attachability of cables guided from the interior of the stator carrier to the outside.

According to the disclosure, in order to achieve this object in an electric machine of the type mentioned at the outset, the annular disc element has at least one cable guide arranged between two adjacent abutment portions, wherein the cable is arranged in the cable guide and the cable guide secures the cable at least in the circumferential direction.

The annular disc element is arranged in the axial direction, i.e., along an axis of rotation of a rotor of the electric machine, on an end face of the stator carrier. The annular disc element comprises radially projecting abutment portions, each of which abuts the stator carrier at least partially. In this regard, the abutment portions can, in each case, abut on the inside of the stator carrier and/or on an axial end face of the stator carrier. In this way, the annular disc element can be fastened to the stator carrier at the multiple abutment portions which are arranged offset along the outer circumference on the annular disc element, for example by clipping the abutment portions to the stator carrier and/or by using fastening means such as screws or the like.

The stator windings of the electric machine are arranged on the stator carrier of the electric machine, in particular on the inside of the stator carrier. In this regard, the stator windings can be fastened directly to the stator carrier, for example to poles projecting from the inside of the stator carrier. It is also possible for the poles to be manufactured separately from the stator carrier and arranged on the inside of the stator carrier. The stator carrier can consist of a hollow-cylindrical element or be composed of multiple elements shaped in the manner of hollow-cylindrical segments. The stator carrier can form a housing of the electric machine, wherein the stator carrier is, for example, a shell housing that at least partially encloses the further components of the electric machine.

The annular disc element can have the shape of a complete annular disc or the shape of an annular disc with a gap, i.e., an annular disc segment which corresponds, for example, to between 320° and less than 360° of the circumference of a complete annular disc. The annular disc element is arranged on an axial end face of the stator carrier, wherein in particular the outer circumference of the annular disc element extends at a distance from the stator carrier in the regions between the abutment portions, so that gaps are formed in regions between the annular disc element and the stator carrier.

According to the disclosure, the annular disc element is an interconnection ring comprising at least one conductor track, wherein the conductor track is connected to one or more stator coils arranged on the stator carrier. The connections between the stator coils and the conductor tracks of the annular disc element can be made via cables or lines, for example, which are guided through the gaps between the annular disc element and the stator carrier, i.e., through the gaps between two adjacent abutment portions.

In the region of such a gap between two abutment portions formed between the stator carrier and the annular disc element, the cable guide is, in particular, also arranged. The at least one cable, which is guided from the interior of the stator carrier to the outside, is arranged in the cable guide so that it can be guided on the annular disc element or through the annular disc element, respectively. In this regard, the cable is secured by the cable guide at least in the circumferential direction, so that it is immovable or at least only movable to a limited extent in the circumferential direction. In particular, the mobility of the cable in the circumferential direction is limited to at least a distance that is smaller than the diameter of the cable.

Securing the cable can involve completely fixing the cable, which does not allow for any movement in the circumferential direction and/or in other directions. In this way, a strain relief can be provided for the cable, for example. It is also possible for the cable to be secured while retaining a certain amount of play so that the cable can move slightly in the circumferential direction. This allows, for example, the cable to still be moved in the axial direction, i.e., it can be pulled out of the stator carrier or pushed into the stator carrier to a certain extent.

Providing the cable guide is advantageous in that the cable is easy to mount when assembling the electric machine. While moving the annular disc element closer to the stator carrier in order to fasten the annular disc element, the cable guided out of the interior of the stator carrier can be arranged in the cable guide before the annular disc element is pressed against the stator carrier and/or otherwise fastened, for example.

The device connected with the cable can, in particular, be a sensor, for example a temperature sensor or a rotor position sensor. The cables from other devices arranged in the interior of the electric machine or in the interior of the stator carrier can also be guided and secured in the cable guide. The devices can, for example, be arranged adjacent to or bordering the stator windings, a rotor shaft of the electric machine or other components of the electric machine located in the interior of the hollow-cylindrical stator carrier.

Providing the cable guide on the circumference of the annular disc element has the further advantage that the cable guide and the orientation of the cables can be implemented with comparative ease as far as the geometry is concerned. Furthermore, no further components need to be mounted during assembly of the electric machine in order to form the cable guide, as the cable guide can advantageously be formed as a component of the annular disc element. The cable guide has the advantage of preventing damage to the cables both during assembly and during operation of the electric machine.

In a preferred embodiment of the disclosure, the cable guide can comprise at least two radially projecting projections arranged offset in the circumferential direction on the outer circumference, wherein the projections each end in front of the stator carrier or abut the stator carrier, wherein the cable is arranged, in particular clamped, between the projections. The projections can, for example, abut the inside of the stator carrier and/or the end face of the stator carrier, so that an intermediate space between the projections is delimited radially outwards by the stator carrier or a portion of the stator carrier.

Alternatively, it is possible for the projections to end in front of the stator carrier, wherein the remaining gap between the projections and the stator carrier is, in particular, smaller than the diameter of the cable arranged in the cable guide, so that the cable cannot slip out of the intermediate space between the projections. The design of the cable guide with at least two radially projecting projections has the advantage that it enables the cables to be secured in the circumferential direction with a comparatively simple geometry. It is possible for the projections to be formed in one piece with further portions of the annular disc element, so that the annular disc element with the cable guide can be manufactured in a simple manner. In this context, additional components advantageously can be dispensed with, in particular since the projections allow for cable guidance purely via the geometry of the annular disc element.

In a preferred embodiment of the disclosure, the cable guide can comprise three or more projections, wherein at least one cable each is arranged between two adjacent projections in each case. It is possible for the annular disc element to comprise a marking and/or code assigned to the individual intermediate spaces, so that the cables or the devices connected with the cable in the interior of the machine can be quickly distinguished during assembly and/or repair of the electric machine. In this regard, the marking or code can be applied to the side of the annular disc element facing outwards, for example. The two or more projections can each have the same geometry or different geometries, in particular different widths in the circumferential direction.

According to the disclosure, the distance between the projections can widen outwards at least in portions. Widening the distance between the projections, or widening the intermediate space between the projections outwards, makes it easier to insert or clamp a cable between the projections.

A distance between the projections that widens outwards in the radial direction can be achieved by the width of the projections decreasing at least in portions in the radially outer direction. Different geometries are conceivable in which the width can decrease continuously, for example along a straight line or along a bent curve. The intermediate space between the projections is accessible from the outside during assembly when the annular disc element is not yet fastened to the stator carrier, so that the cable guided out of the interior of the machine can be easily arranged in the cable guide.

In a preferred embodiment of the disclosure, at least one pair of cables arranged offset in the radial direction can be secured in the cable guide. This can be, for example, a ground cable and a signal cable of a device arranged in the interior of the electric machine. During assembly, the cables can be arranged or pressed into the intermediate space between two projections one after the other, for example, so that the cables are secured in a well-arranged and robust manner.

According to the disclosure, the annular disc element can have at least one cable guide means and/or at least one fastening means on the side facing the interior of the stator carrier, by means of which at least one device connected with the cable, in particular a temperature sensor, is fastened to the annular disc element. The cable guide means or the fastening means thus point towards the interior of the stator carrier or the interior of the electric machine. A device connected with the cable, for example a temperature sensor, can be fastened to the annular disc element via the fastening means.

The cables connected to the device can be guided via the cable guide means along the side of the annular disc element facing the interior and thus, for example, be moved closer to the cable guide on the outer circumference of the annular disc element. The cable guide means and/or the fastening means can, for example, be arranged adjacent to or in the immediate vicinity of the cable guide so that the overall cabling is as short as possible. For example, the temperature of a stator winding in the immediate vicinity can be measured using a temperature sensor fastened to the fastening means.

The advantage of fastening the device to the annular disc element via the fastening means is that when the electric machine is assembled, a device connected with the cable does not have to be mounted blindly in the interior of the machine, but can be arranged on the annular disc element before it is attached. Blind mounting of the device connected with the cable in the interior of the electric machine can thus advantageously be dispensed with.

In a preferred embodiment of the disclosure, the cable guide means can be a pair of projections or a pin and/or the fastening means can be a fastening clip. In this regard, the pins can project in the axial direction towards the interior of the stator carrier from the inner side of the annular disc element facing the interior of the stator carrier. The fastening clip can also be fastened in axial projections of the annular disc element on the inner side of the annular disc element. The fastening clip allows the device, for example the temperature sensor, to be pressed against the inner side of the annular disc element.

According to the disclosure, at least one contact means connected with the cable, in particular a plug or a socket, can be arranged on the side of the annular disc element opposite the interior of the stator carrier. In this regard, the contact means is arranged on the outside of the electric machine or the annular disc element, so that the device located in the interior of the electric machine can be contacted via the contact means. The contact means can be designed as a plug or a socket, for example, so that it can be connected to one or more further cables. Preferably, the contact means is arranged adjacent to the cable guide so that the shortest possible cables can be used.

Furthermore, according to the disclosure, the contact means and the cable can be fastened to a retaining element, wherein the retaining element is arranged, in particular adjacent to the cable guide, on the side of the annular disc element opposite the interior of the stator carrier. The retaining element can, for example, be designed in the manner of a clamp and can be fastened to the outer side of the annular disc element opposite the interior of the stator carrier, for example by clipping it in place. It can be used to guide the cable portions that project outwards from the cable guide so that these portions can also be secured to the electric machine. Furthermore, the retaining element can also hold the contact means, so that it can also be easily fastened to the annular disc element or to the electric machine.

The use of the retaining element makes it easy to assemble the electric machine, as the retaining element can be fastened to the annular disc element once the annular disc element has been arranged on the stator carrier of the electric machine. The cable and the contact means can then be arranged on the retaining element.

### BRIEF DESCRIPTION OF THE DRAWINGS

The disclosure is explained below on the basis of exemplary embodiments with reference to the drawings. The drawings are schematic representations, in which:

FIG. 1 shows a schematic view of an exemplary embodiment of an electric machine according to the disclosure,

FIG. 2 shows a detailed view of the cable guide of the exemplary embodiment of the electric machine,

FIG. 3 shows a further exemplary embodiment of a cable guide of the exemplary embodiment of the electric machine according to the disclosure,

FIG. 4 shows a detailed view of the side of the annular disc element of the exemplary embodiment of the electric machine according to the disclosure facing the interior of the electric machine,

FIG. 5 shows a detailed view of a temperature sensor of the exemplary embodiment of the electric machine,

FIG. 6 shows a detailed view of an assembly state of the exemplary embodiment of the electric machine according to the disclosure, and

FIG. 7 shows a further assembly view of the exemplary embodiment of the electric machine according to the disclosure.

### DESCRIPTION OF EMBODIMENTS

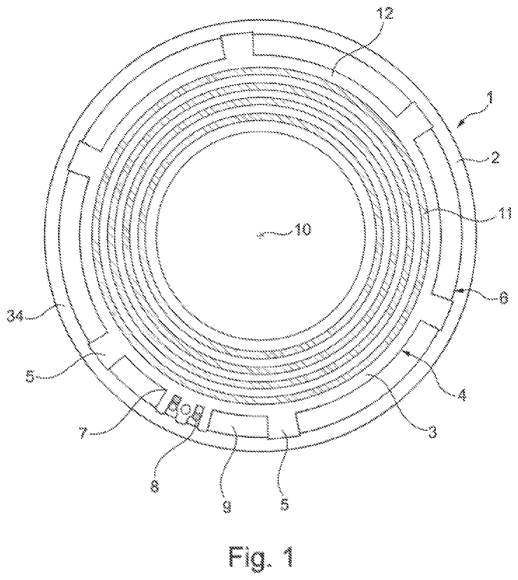

FIG. 1 shows an exemplary embodiment of an electric machine 1. The electric machine 1 comprises a hollow-cylindrical stator carrier 2 and an annular disc element 3 arranged on an axial end face of the stator carrier 2. The outer circumference 4 of the annular disc element 3 comprises multiple radially projecting abutment portions 5 with which the annular disc element 3 abuts the stator carrier 2. The stator carrier 2 can have multiple stator coils (not shown) forming the stator winding of the electric machine 1 on its inside 6.

Furthermore, the annular disc element 3 comprises at least one cable guide 7 arranged between two adjacent abutment portions 5 as well as multiple cables 8 guided outwards from an interior of the stator carrier 2 or the interior of the electric machine 1. In this regard, the cables 8 are arranged in the cable guide 7 and are secured by the cable guide 7 at least in the circumferential direction of the electric machine 1.

The annular disc element 3 is arranged on the axial end face of the stator carrier 2 and is fastened to the stator carrier 2, for example by clipping the abutment portions 5 in place. In addition or as an alternative, other fastening means can also be used. In the present case, the cable guide 7 is arranged between two of the abutment portions 5 arranged equidistantly around the circumference of the annular disc element 3. Alternatively, it is also possible for the cable guide 7 to replace one of the equidistantly arranged abutment portions 5, in particular if the annular disc element 3 can also be fastened to the stator carrier 2 via the cable guide 7, as described in more detail below.

The cable guide 7 secures the cables 8 at least in the circumferential direction, which means that the cables 8 cannot move along a gap 9 between the two abutment portions 5, at least in the circumferential direction. It is possible for the cables 8 to have a certain amount of play within the cable guide 7 so that they can be moved, for example, in the axial direction, i.e., along a rotation axis 10 of the electric machine. This allows the cables 8 to be pushed into the interior of the stator carrier 2 or pulled out of the interior of the stator carrier 2.

The abutment portions 5 serve to support the annular disc element 3 on the stator carrier 2. In particular, it is possible for the abutment portions 5 to clamp onto the stator carrier 2 when the annular disc element 3 is arranged so that the annular disc element 3 can be easily secured to the stator carrier 2. The abutment portions 5 can be designed with different geometries. It is possible for the surfaces of the abutment portions 5, which are orthogonal to the rotation axis 10 in the radial plane, to have a ribbed structure.

The annular disc element 3 is designed as an interconnection ring and comprises several conductor tracks 11, which are arranged on a side 12 of the annular disc element 3 opposite the interior of the stator carrier 2. The conductor tracks 11 are used to connect the stator coils arranged on the inside 6 of the stator carrier 2. For this purpose, conductors and/or cables can be guided through the gaps 9 between the abutment portions 5 and connected to the conductor tracks 11, for example by soldering or welding.

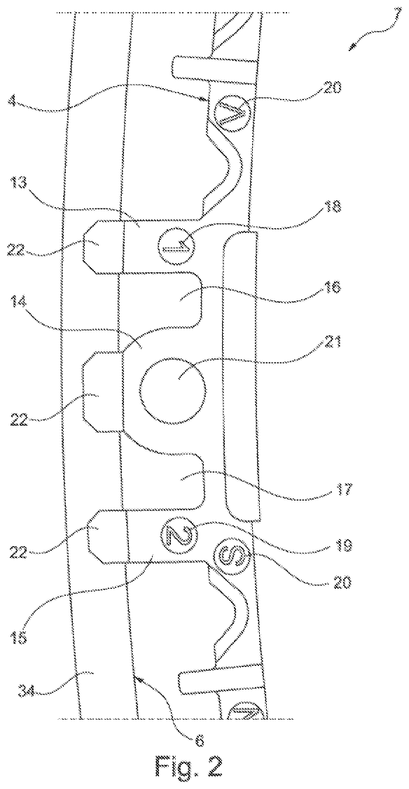

FIG. 2 shows a detailed view of the cable guide 7 of the annular disc element 3. The cable guide 7 comprises multiple radially projecting projections 13, 14, 15 arranged offset in the circumferential direction on the outer circumference 4 of the annular disc element 3. In particular, the projections 13-15 can be formed in one piece with further portions of the annular disc element 3, for example the base body of the annular disc element 3, which also has the abutment portions 5. This allows for the annular disc element 3 to be manufactured in a simple manner.

The projections 13-15 can each end at the stator carrier 2, as shown in FIG. 1. This allows the annular disc element 3 to also be fastened to the stator carrier 2 via the cable guide 7. Alternatively, it is possible for the projections 13-15 to end in front of the inside 6 of the stator carrier 2, wherein in particular a remaining gap between the projections 13-15 and the inside 6 of the stator carrier 2 is smaller than the diameter of the cables 8 arranged in the cable guide 7, so that these can be secured in the circumferential direction.

For the purposes of securing the cables in the cable guide 7, the cables 8 are arranged in the intermediate spaces 16, 17 between two adjacent projections 13-15. To identify a device connected with the cables 8, for example a sensor connected via the cables 8, the annular disc element 3 can have markings or codes 18, 19 which designate the respective devices contacted via the cables 8 arranged in the adjacent intermediate spaces 16 or 17. This makes it easier to identify the devices that can be contacted or are contacted via the cables 8 in the assembled state of the electric machine 1. In addition to this, further markings or codes 20 can be provided, which designate the lines guided in the gaps 9 for connecting the stator coils or the stator coils and/or winding phases contacted via these lines.

The geometry of the projections 13-15 can, for example, be essentially rectangular, as shown for the projections 13 and 15. It is also possible that all or some of the projections have a different geometry, for example an annular geometry in portions, as shown for the projection 14. This makes it possible for the projections 13-15 to be at least partially provided with openings 21, so that the weight of the annular disc element 3 can advantageously be reduced and/or the manufacture of the annular disc element 3 in a mold can be simplified.

The distance between two adjacent projections 13-15 can widen outwards in the radial direction, so that the insertion or clamping of the cables 8 between the projections 13-15 is facilitated during the assembly of the electric machine 1. To this end, the projections 13-15 can have a decreasing width in the circumferential direction, at least in regions, in one end portion 22 each. Like the abutment portions 5, the end portions 22 abut an axial end face 34 of the stator carrier 2 in regions.

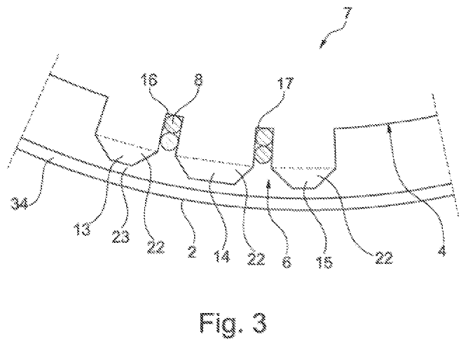

FIG. 3 shows a further exemplary embodiment of the cable guide 7. In this exemplary embodiment, the projections 13-15 are shaped in such a way that a pair of cables 8 arranged offset in the radial direction is secured in the intermediate spaces 16 to 17 in each case. In this regard, the cables 8 can, for example, form a ground line and a signal line for a device connected via one of the cables 8. In this exemplary embodiment of the cable guide 7, the projections 13-15 also each comprise an end portion 22 with a width that decreases in portions radially outwards. The intermediate spaces 16, 17 between the projections 13-15 thus, in each case, widen radially outwards in portions. This makes it easier to insert the cables 8 into the cable guide 7 during assembly of the electric machine 1.

In this exemplary embodiment of the cable guide 7, the projections 13-15 end in front of the stator carrier 2. Alternatively, it is possible for the projections 13-15 to rest on the axial end face 34 of the stator carrier 2, for example with their end portions 22, as described above with reference to FIG. 2. In the case where the projections 13-15 end in front of the inside 6 of the stator carrier 2, the remaining gap 23 between the projections and the inside 6 is smaller than the diameter of the cables 8 in each case, so that they cannot slip out of the intermediate spaces 16, 17 in the circumferential direction. It is possible for the cables 8 to be clamped between the respective adjacent projections 13-15, so that they are immovable both in the circumferential direction and in the axial direction, which in FIG. 3 is orthogonal to the drawing plane.

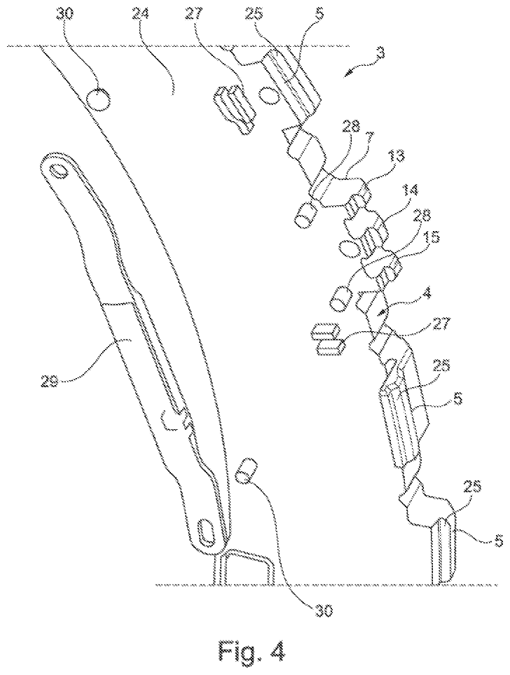

FIG. 4 shows a detailed view of the side 24 of the annular disc element 3 facing the interior of the stator carrier 2. Multiple abutment portions 5 can also be seen. In this regard, the abutment portions 5 have a portion 25 with which the abutment portions 5 can abut the axial end face 34 of the stator carrier 2. In addition or alternatively, the abutment portions 5, or at least part of the abutment portions 5, can also have a surrounding portion 26 with which the annular disc element 3 can be clamped to the inside 6 of the stator carrier 2.

The annular disc element 3 comprises multiple cable guide means 27, 28 and a fastening means 29 on the inner side 24 facing the interior of the stator carrier 2. In this regard, the cable guide means 27 are designed as pairs of projections extending in the axial direction into the interior of the stator carrier 2, between which one or more cables 8 can be clamped for strain relief purposes. The cable guide means 28 are designed as pins, which also extend in the axial direction into the interior of the stator carrier 2, and which allow for cable guidance on the inner side 24 of the annular disc element.

The fastening means 29 is designed as a fastening clip. The fastening clip can be fastened to one or more pins 30, which are arranged on the side 24 of the annular disc element 3 facing the interior of the stator carrier 2. A device connected via the cables 8 can be fastened to the annular disc element 3 at the fastening means 29. The fastening means 29 enables the annular disc element 3 to be fastened directly to the stator carrier 2 of the electric machine 1 during assembly of the electric machine 1 with one or more devices fastened to the fastening means 29. The device fastened to the outer side 24 of the annular disc element 3 by the fastening means 29 can, for example, be a temperature sensor.

Advantageously, the cables, which are guided to the outside from the devices fastened to the fastening means 29, can already be secured in the cable guide means 28, 29 and the cable guide 7, so that a simple assembly of the electric machine 1 is possible. An interfering influence of the cables 8 on the arrangement of the outer circumference 4 of the annular disc element 3 on the stator carrier 2 can thus advantageously be avoided, in particular if the cables 3 are clamped in the cable guide 7.

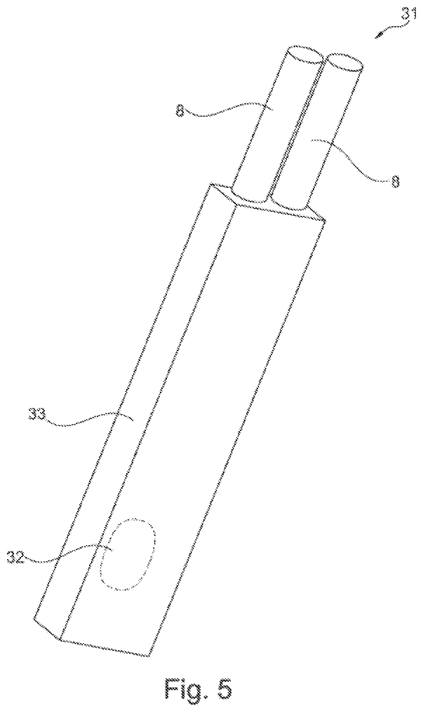

FIG. 5 shows an exemplary embodiment of a device 31 contacted via the cables 8. In the present case, the device 31 is designed as a temperature sensor and comprises a temperature sensor element 32, which is arranged within a sheath 33, for example a shrink tube. The sheath 33 of the temperature sensor means 32 can, in particular, have a rectangular geometry. The temperature sensor element 32 can be designed as a sensor chip and can be, for example, an NTC or a PTC temperature sensor.

The temperature sensor element 32 is connected with the cables 8, which, as shown above, can be guided from the interior of the stator carrier 2 to the outside via the cable guide 7. The temperature sensor element 32 can be connected with the cables 8 in the interior of the sheath 33, for example by welding or crimping. For example, two devices 31 designed as temperature sensors can be fastened to the fastening means 29 described above, wherein the respective pairs of cables 8 are each guided to the outside through one of the intermediate spaces 16, 17 between the projections 13-15.

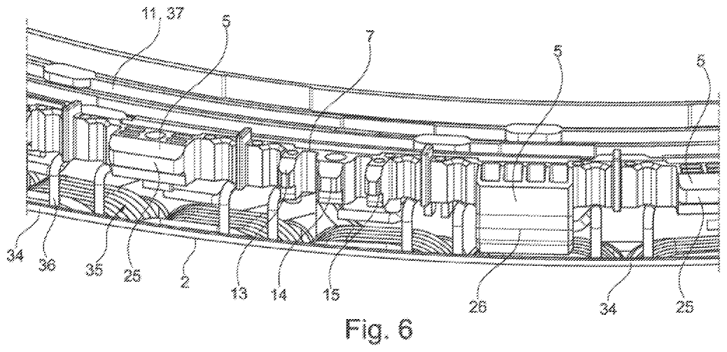

FIG. 6 shows a state during the assembly of the electric machine 1. Here, the annular disc element 3 is arranged offset from the axial end face 34 of the stator carrier 2. A plurality of stator coils 35 and a plurality of lines 36 can be seen, with which the stator windings 25 can be connected to the contact rings 11 running in troughs 37 on the outer side 12 of the annular disc element 3. The cables 8, which are secured in the cable guide 7, are not shown.

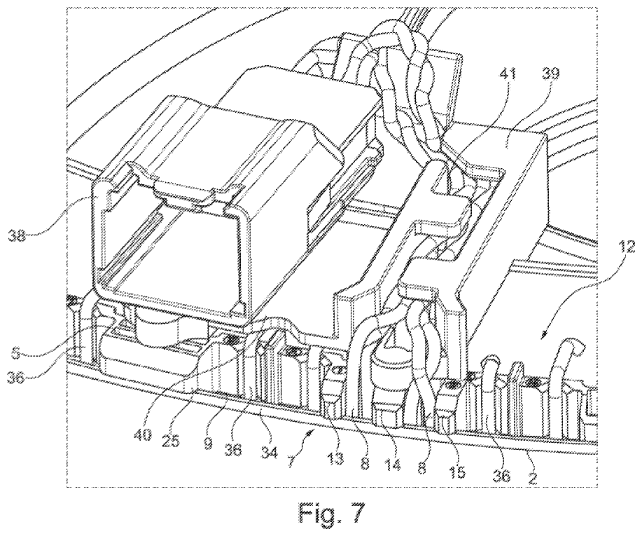

FIG. 7 shows a further assembly position of the electric machine 1. Here, the annular disc element 3 already abuts the stator carrier 2 and is fastened thereto. It can be seen that the annular disc element 3 rests with the portions 25 of the abutment portion 5 on the axial end face 34 or the outer circumference of the stator carrier 2, respectively. The end portions 22 of the projections 13-15 of the cable guide 7 also rest on the outer end face 34.

Also shown is a contact means 38, which is connected with the cables 8. On the outer side 12 of the annular disc element 13, the cables 8 are guided in a retaining element 39. The contact means 38, which is shown in the present case at a distance from the retaining means 39, can also be fastened to the retaining element 39 in a corresponding receptacle 40 of the latter. This makes it possible to fasten almost the entirety of the portions of the cables 8 and the contact means 38 to the retaining means 39 in a stable manner and thus to the annular disc element 3 or the electric machine 1. The retaining means 39 can, for example, be designed as a plastic element that can be fastened to the annular disc element 3.

The contact means 38 can, for example, be designed as a male or female plug or as a socket. The devices arranged in the interior of the electric machine 1, for example two temperature sensors fastened to the inner side 24 of the annular disc element 3 as described above, can be contacted and/or read out via the contact means 38. The conductor tracks 11, which are located on the outer side 12 of the annular disc element 3, are not shown in FIG. 7 for reasons of clarity. The lines 36 guided from the stator coils 35 through the gap 9 are connected to the conductor tracks 11, for example by welding.

The contact element 38 can be arranged in a temporary parking position next to the outer lateral surface of the stator carrier 2 during assembly of the electric machine 1, for example during process steps such as bending the lines 36, which are designed as wires, for example, welding the lines 36 to the conductor tracks 11 and/or encapsulating the annular disc element 3, in particular in the region of the conductor tracks 11, so that the entire outer side 12 of the annular disc element 3 is accessible. Advantageously, the cables 8 can lie along the cable guide 7 without the contact element 38 leaving the intended parking position. The retaining means 39 can then be fastened, for example clipped, to the outside of the stator carrier 2. The cables 8 can then be arranged in a cable guide portion 41 of the retaining means 39 and the contact element 38 in the receptacle 40.

### LIST OF REFERENCE SYMBOLS

1 Electric machine
2 Stator carrier
3 Annular disc element
4 Outer circumference
5 Abutment portion
6 Inside
7 Cable guide
8 Cable
9 Gap
10 Rotation axis
11 Conductor track
12 Outer side
13 Projection
14 Projection
15 Projection
16 Intermediate space
17 Intermediate space
18 Marking
19 Marking
20 Marking
21 Opening
22 End portion
23 Gap
24 Inner side
25 Portion
26 Surrounding portion
27 Cable guide means
28 Cable guide means
29 Fastening means
30 Pin
31 Device
32 Temperature sensor element
33 Sheath
34 End face
35 Stator coil
36 Line
37 Trough
38 Contact means
39 Retaining means
40 Receptacle
41 Cable guide portion

1. An electric machine comprising a hollow-cylindrical stator carrier, at least one cable guided out from the interior of the stator carrier, and an annular disc element arranged on an axial end face of the stator carrier, wherein the outer circumference of the annular disc element has radially projecting abutment portions by means of which the annular disc element abuts the stator carrier, wherein the annular disc element has at least one cable guide arranged between two adjacent abutment portions, wherein the cable is arranged in the cable guide and the cable guide secures the cable at least in the circumferential direction.

2. The electric machine according to claim 1, wherein the cable guide comprises at least two radially projecting projections arranged offset in the circumferential direction on the outer circumference, wherein the projections each end in front of the stator carrier or abut the stator carrier, wherein the cable is arranged, in particular clamped, between the projections.

3. The electric machine according to claim 2, wherein the cable guide comprises three or more projections, wherein at least one cable each is arranged between two adjacent projections in each case.

4. The electric machine according to claim 2, wherein the distance between the projections widens outwards at least in portions.

5. The electric machine according to claim 1, wherein at least one pair of cables arranged offset in the radial direction is secured in the cable guide.

6. The electric machine according to claim 1, wherein the annular disc element has at least one cable guide means and/or at least one fastening means on the side facing the interior of the stator carrier, by means of which at least one device connected with the cable, in particular a temperature sensor, is fastened to the annular disc element.

7. The electric machine according to claim 6, wherein the cable guide means is a pair of projections or a pin and/or in that the fastening means is a fastening clip.

8. The electric machine according to claim 1, wherein at least one contact means connected with the cable, in particular a plug or a socket, is arranged on the side of the annular disc element opposite the interior of the stator carrier.

9. The electric machine according to claim 8, wherein the contact means and the cable are fastened to a retaining element, wherein the retaining element is arranged, in particular adjacent to the cable guide, on the side of the annular disc element opposite the interior of the stator carrier.

10. The electric machine according to claim 1, wherein the annular disc element is an interconnection ring comprising at least one conductor track, wherein the conductor track is connected to one or more stator coils arranged on the stator carrier.

11. An electric machine comprising:
a stator carrier;
at least one cable guided from an interior of the stator carrier; and
an annular disc element connected to an end face of the stator carrier,
wherein an outer circumference of the annular disc element comprises abutment portions,
wherein the abutment portions cause the annular disc element to abut the stator carrier,
wherein the annular disc element comprises at least one cable guide arranged between two adjacent abutment portions,
wherein the cable is arranged in the cable guide and the cable guide secures the cable in at least the circumferential direction.

12. The electric machine according to claim 1, wherein the cable guide comprises at least two radially-projecting projections arranged offset in the circumferential direction on the outer circumference, wherein the cable is arranged between the projections.

13. The electric machine according to claim 13, wherein the distance between the projections widens outwards at least in portions.

14. The electric machine according to claim 1, wherein at least one pair of cables arranged offset in the radial direction is secured in the cable guide.

15. The electric machine according to claim 1, wherein at least one device connected with the cable is fastened to the annular disc element.

16. The electric machine according to claim 6, wherein the at least one device comprises a temperature sensor.

17. The electric machine according to claim 1, wherein a contact means connected with the cable is arranged on the side of the annular disc element opposite the interior of the stator carrier.

18. The electric machine according to claim 17, wherein the contact means and the cable are fastened to a retaining element, wherein the retaining element is arranged on the side of the annular disc element opposite the interior of the stator carrier.

19. The electric machine according to claim 1, wherein the annular disc element comprises an interconnection ring comprising at least one conductor track, wherein the conductor track is connected to one or more stator coils arranged on the stator carrier.

20. A method of securing a cable within an electric machine comprising:
providing a stator carrier of the electric machine;
securing at least one cable from an interior of the stator carrier with a cable guide of an annular disc element;
connecting the annular disc element to an end face of the stator carrier; and
abutting the annular disc element to the stator carrier with a set of abutment portions positioned on an outer circumference of the annular disc element.
